(19) United States
(12) Patent Application Publication
(10) Pub. No.: US 2026/0320690 A1
(43) Pub. Date: Oct. 15, 2026

(54) System and Method for Blockchain-Based Investment Management of Real Estate Tax Liens

(71) Applicant: Dameon D Booker, Signal Hill, CA (US)

(72) Inventor: Dameon D Booker, Signal Hill, CA (US)

(21) Appl. No.: 19/173,852

(22) Filed: Apr. 9, 2025

(51) Int. Cl. G06Q 40/04; G06Q 20/36; G06Q 20/38; G06Q 40/10; G06Q 50/163

(52) U.S. Cl. CPC G06Q 40/055; G06Q 20/36; G06Q 20/389; G06Q 40/10; G06Q 50/163; G06Q 2220/00

(57) ABSTRACT

A system and method for facilitating the purchase and management of real estate tax liens through individual and group investments using digital currency on a Polygon blockchain platform. The invention tokenizes tax lien certificates as unique digital assets, enabling fractional ownership and enhanced liquidity through a secondary market. Smart contracts automate various aspects of tax lien investments, including due diligence, legal compliance, interest calculation, redemption processing, and foreclosure initiation. For group investments, the system implements a decentralized governance model where decision-making power is proportional to each member's ownership stake, while maintaining transparency through blockchain-based record-keeping. By leveraging blockchain technology and digital currency, the invention simplifies complex aspects of tax lien purchasing and management while enhancing efficiency, transparency, and accessibility for investors.

### CROSS-REFERENCE TO RELATED APPLICATIONS

This application claims the benefit of U.S. Provisional Application No. 63/632,523, filed Apr. 10, 2024, the entire contents of which are hereby incorporated by reference.

### FIELD OF THE INVENTION

The present invention generally relates to the field of real estate investments, particularly to a system and method that enables individuals and groups to invest in real estate tax liens using digital currency on a Polygon blockchain platform, offering a structured approach to manage such investments, including options for redemption, foreclosure, and liquidity through a secondary market.

### BACKGROUND OF THE INVENTION

Real estate tax liens represent a specialized investment opportunity that arises when property owners fail to pay their property taxes. Local governments issue tax lien certificates to investors who pay the delinquent taxes, allowing the government to recover the owed funds immediately. In return, the investor receives the right to collect the tax amount plus interest from the property owner. If the property owner fails to pay within a specific redemption period, the investor may have the right to foreclose on the property.

Traditional methods of investing in real estate tax liens involve navigating complex legal frameworks, conducting extensive property research, and managing the investment through its lifecycle, which can be daunting and inaccessible for many investors. There exists a need for a streamlined platform that simplifies this process, making tax lien investments more accessible and manageable, especially for those lacking expertise in real estate or legal matters.

Several challenges persist in the traditional tax lien investment process. First, purchasing tax liens often requires physical presence at auctions or navigating complex county-specific procedures, limiting access to local investors or those with specialized knowledge. Second, property due diligence requires expertise and resources that many individual investors lack. Third, managing the investment through redemption, subsequent tax payments, and potential foreclosure processes involves complex legal procedures that vary by jurisdiction.

Previous attempts to streamline tax lien investments have included online auction platforms and investment funds that pool resources to purchase tax liens. However, these solutions often lack transparency, charge high management fees, or do not provide investors with sufficient control over their investments. Additionally, liquidity remains a significant challenge, as tax lien investments traditionally have no secondary market for investors to exit before redemption or foreclosure.

Integrating digital currency and blockchain technology offers promising solutions to these challenges. Blockchain technology provides transparency, security, and automation through smart contracts, while digital currencies enable faster, borderless transactions with reduced intermediary costs. The Polygon blockchain, in particular, offers scalability, low transaction costs, and compatibility with Ethereum, making it an ideal platform for a tax lien investment application.

### SUMMARY OF THE INVENTION

The present invention is directed to a system and method for facilitating the purchase and management of real estate tax liens through an application built on the Polygon blockchain platform. The invention enables both individual and group investments using digital currency, specifically the platform's native currency (MATIC).

In accordance with one aspect of the invention, the application provides a comprehensive framework for managing tax lien investments through their entire lifecycle, including property selection, due diligence, purchase, redemption tracking, subsequent tax payments, and foreclosure processes.

In accordance with another aspect of the invention, the application implements a novel system for managing group investments where decision-making power is proportional to each member's ownership stake, with certain critical actions requiring majority or supermajority votes from all members.

In accordance with yet another aspect of the invention, the application tokenizes tax lien certificates as unique digital assets on the Polygon blockchain, enabling fractional ownership and enhanced liquidity through a secondary market where users can sell their tokens.

The invention addresses key challenges in traditional tax lien investments by leveraging blockchain technology to enhance transparency, automation, and accessibility while reducing costs and complexity. By tokenizing tax liens and providing a secondary market, the invention also solves the liquidity problem inherent in traditional tax lien investments.

### BRIEF DESCRIPTION OF THE DRAWINGS

FIG. 1 is a schematic diagram illustrating the overall system architecture of the application.

FIG. 2 is a flowchart illustrating the user journey from registration to investment.

FIG. 3 is a flowchart illustrating the group investment process and governance structure.

FIG. 4 is a diagram illustrating the tokenization process of tax lien certificates.

FIG. 5 is a flowchart illustrating the redemption and distribution process.

FIG. 6 is a flowchart illustrating the foreclosure process.

FIG. 7 is a diagram illustrating the secondary market functionality.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

### System Architecture

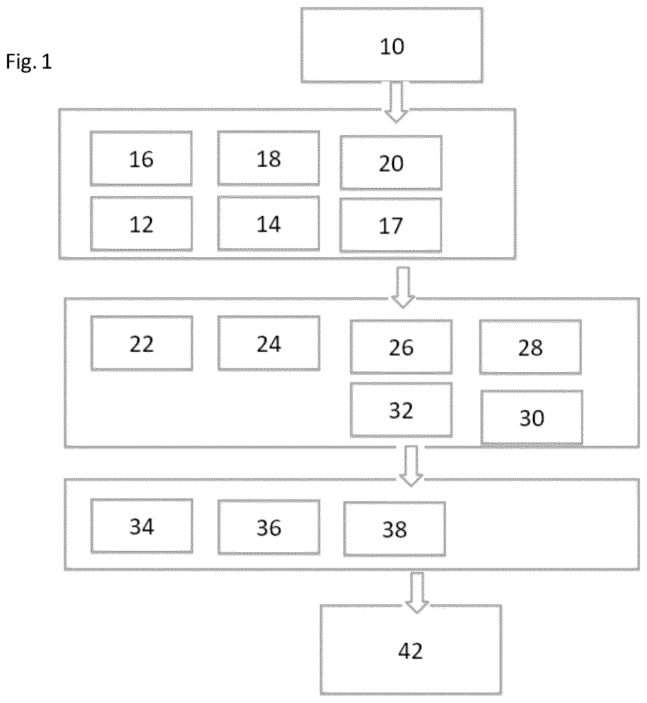

Referring to FIG. 1, the system architecture includes a Polygon blockchain platform (10) that provides the foundational distributed ledger infrastructure supporting a smart contracts layer (11) containing interconnected smart contracts including tax lien token contract (12), secondary market contract (14), user management contract (16), foreclosure management contract (17), group investment contract (18), and redemption and distribution contract (20). The application modules layer (21) comprises specialized software components including digital wallet interface module (22) for MATIC transaction management, group investment module (24) for collaborative investment coordination, risk assessment module (26) for AI-driven investment analysis, tokenization module (28) for NFT creation and metadata management, secondary market module (30) for trading facilitation, and educational module (32) for user guidance and compliance training. The system architecture integrates with external services layer (33) including title search companies (34) for property due diligence, local government databases (36) for tax lien data acquisition, and legal service providers (38) for foreclosure process assistance, with all system components accessible through a unified user interface (42) that provides secure, role-based access to platform functionality

The application interfaces directly with external systems, including title search services for property validation, government databases for obtaining accurate tax lien data, and legal service providers to facilitate foreclosure processes. All transactions and critical data are stored on the Polygon blockchain, ensuring transparency and immutability.

### Polygon Blockchain and Digital Currency Integration

The application is built on the Polygon blockchain platform, leveraging its scalability, speed, and low transaction costs. Polygon, as a Layer 2 scaling solution for Ethereum, inherits Ethereum's security while providing faster and more cost-effective transactions, making it ideal for the frequent small-to-medium transactions involved in tax lien investments.

Users can purchase tax liens and receive investment returns using the platform's native digital currency (MATIC), allowing for fast, borderless transactions and reducing the need for traditional banking intermediaries. The application includes a wallet interface that enables users to manage their MATIC holdings, track transaction history, and authorize payments for tax lien purchases.

### Enhanced Smart Contract Architecture

The application implements a multi-layered smart contract architecture that goes beyond traditional automation. The system utilizes advanced features of the Polygon blockchain, including:
a. Regulatory-Compliant Smart Contracts: The application incorporates dynamically updatable compliance parameters to adjust to evolving SEC requirements for tokenized real estate. These smart contracts automatically verify investor accreditation status, implement holding periods as required by regulations, and maintain comprehensive transaction records for regulatory reporting.
b. Interoperability Protocols: The system leverages cross-chain bridges to enable communication between the Polygon blockchain and other prominent blockchain networks, including Ethereum, Binance Smart Chain, and Solana. This interoperability significantly enhances secondary market liquidity by allowing tax lien tokens to be traded across multiple platforms and ecosystems.
c. Dynamic NFT Implementation: Rather than static tokenization, the system implements ERC-721 tokens with dynamic metadata capabilities, allowing the tokens to automatically update with relevant information such as redemption status, interest accrual, property improvements, and changes in legal standing, enhancing transparency and reducing information asymmetry among investors.
d. Oracle Integration: The smart contract architecture incorporates decentralized oracle networks to feed real-world data into the tokenized assets, enabling automatic valuation adjustments based on external events such as property value changes, interest rate fluctuations, and local market conditions, supporting more accurate real-time pricing.

Key smart contracts in the system include:
a. User Management Contract: Handles user registration, KYC/AML verification, and permission management.
b. Tax Lien Token Contract: Manages the creation, transfer, and redemption of tokenized tax lien certificates.
c. Group Investment Contract: Governs group formation, contribution management, and decision-making processes.
d. Secondary Market Contract: Facilitates the listing, bidding, and transfer of tax lien tokens on the secondary market.
e. Redemption and Distribution Contract: Automatically processes redemption payments and distributes returns to investors based on their ownership percentage.
f. Foreclosure Management Contract: Tracks redemption deadlines and initiates foreclosure processes when necessary, generating required legal documentation.
g. Compliance Engine Contract: Implements regulatory compliance checks and manages jurisdiction-specific requirements for tokenized real estate assets.
h. Risk Assessment Contract: Interfaces with data analytics modules to provide real-time risk analysis for investments.

These smart contracts interact with each other to create a seamless user experience while ensuring security, transparency, and compliance with local tax lien laws.

### Dynamic Tokenization System

The application tokenizes tax lien certificates, representing them as unique digital assets (non-fungible tokens or NFTs) on the Polygon blockchain. Each token contains metadata about the underlying tax lien, including property information, purchase date, interest rate, redemption deadline, and ownership history.

Tokenization enables fractional ownership, allowing multiple investors to own portions of a single tax lien. This democratizes access to tax lien investments by reducing the minimum investment amount and enabling portfolio diversification.

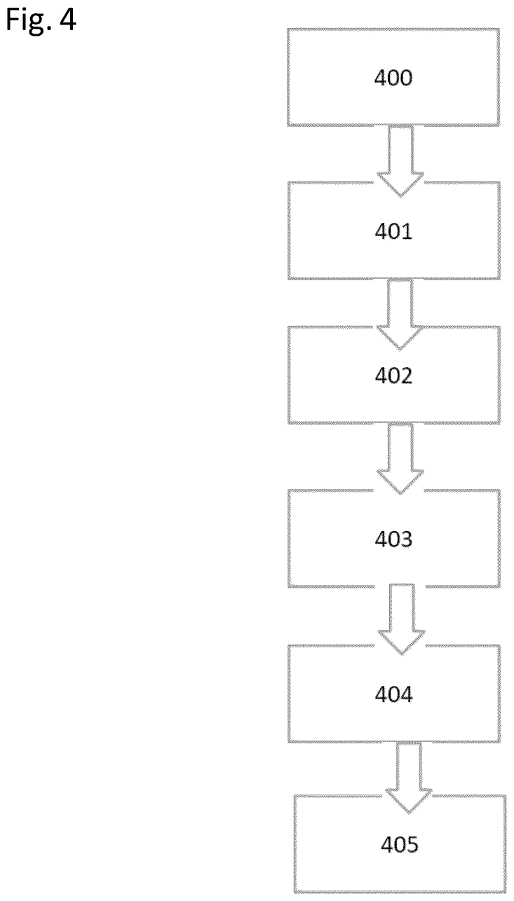

Referring to FIG. 4, the tokenization process begins with retrieve tax lien information from government database (400) where the system automatically queries local government tax databases to obtain comprehensive tax lien certificates and associated property records. The system then proceeds to verify tax lien information and property details (401) through integration with title search companies and property validation services to ensure accuracy and legal compliance. Next, the system creates digital representation with metadata (402) by compiling all relevant tax lien information into a structured digital format suitable for blockchain tokenization. The process continues with mint non-fungible token (NFT) on Polygon blockchain (403) utilizing the ERC-721 standard to generate unique digital assets that represent ownership of the underlying tax lien certificates. Finally, the system executes assign token to purchaser's wallet or group contract (404) transferring the newly minted token to either individual investor wallets for direct ownership or to group investment smart contracts for collaborative ownership structures. The tokenization process includes comprehensive token metadata (405) containing property information, tax lien information, purchase date and redemption deadline, and ownership details, enabling dynamic updates and real-time tracking of investment status throughout the tax lien lifecycle.

The system utilizes the ERC-721 standard with dynamic metadata capabilities, allowing the tokens to automatically update with relevant information such as redemption status, interest accrual, property improvements, and changes in legal standing. This dynamic token structure enhances transparency and reduces information asymmetry among investors by ensuring all token holders have access to the most current information about their investments.

### Advanced Secondary Market Features

The application's secondary market module introduces several innovative features: Alternative Trading System (ATS) Compatibility: The platform is designed to integrate with SEC-registered Alternative Trading Systems, ensuring that secondary market transactions comply with securities regulations while maximizing token liquidity. This compatibility includes standardized APIs for order book management, trade execution, and settlement processes.
a. Automated Compliance Verification: Before executing any transfer on the secondary market, the platform's compliance engine automatically verifies that the transaction meets all applicable regulatory requirements, including investor accreditation, KYC/AML compliance, and holding period restrictions. This verification process utilizes zero-knowledge proofs to maintain privacy while ensuring compliance.
b. Liquidity Pools and Automated Market Making: To enhance liquidity for less actively traded tax lien tokens, the platform implements customized automated market making algorithms and liquidity pool protocols. These features ensure that investors can enter or exit positions efficiently with minimal slippage, even for tax liens in less populous jurisdictions.
c. Cross-Platform Settlement: The application implements atomic swap protocols to facilitate secure cross-platform settlement, allowing investors to trade tax lien tokens across different blockchain environments without counterparty risk.

### Automated Management and Enhanced Compliance

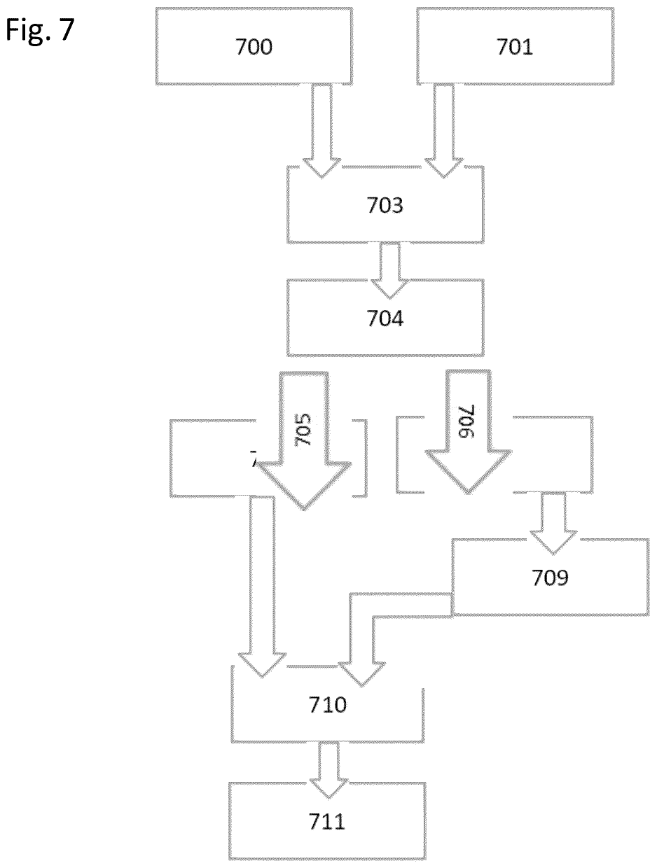

Referring to FIG. 7, the secondary market functionality enables token holder lists token for sale (700) where investors can offer their tax lien tokens through two distinct mechanisms. For direct sale transactions (705), the system facilitates buyer purchases at listed price (707) enabling immediate transactions at predetermined prices. For auction-based transactions (706), the system initiates bidding period (708) allowing multiple potential buyers to compete for token ownership. During auction processes, highest bidder wins (701) determines the successful purchaser, followed by smart contract transfers token (702) automatically executing the ownership transfer on the blockchain. The system then processes payment distributed to seller (703) transferring the sale proceeds to the original token holder's digital wallet. Similarly, for auction completions, the highest bidder wins (709) mechanism determines the successful buyer, followed by smart contract transfers token (710) executing the automated ownership transfer, and concluding with payment distributed to seller (711) completing the secondary market transaction with full blockchain transparency and automated settlement procedures.

The application automates various management aspects of tax lien investments, including:
a. Due Diligence: Integration with title search companies for property vetting, with information stored on the blockchain for transparency. The application provides users with comprehensive property reports, including ownership history, liens, encumbrances, and market value estimates.
b. Legal Compliance: Smart contracts ensure compliance with local tax lien laws and automatically track redemption periods and deadlines. The application maintains a database of jurisdiction-specific rules and adapts its processes accordingly.
c. Investment Options Pre-selection: Enables users to choose their preferred course of action before the redemption period ends, with smart contracts executing the selected option. Options include automatic reinvestment of redeemed funds, distribution to wallet, or listing on the secondary market.

The application also implements a comprehensive regulatory compliance framework designed to adapt to the evolving legal landscape of tokenized real estate:
a. Multi-Jurisdictional Compliance Engine: The system includes configurable compliance parameters that can be adjusted based on jurisdiction-specific requirements, allowing the platform to operate across multiple regulatory environments while maintaining full compliance in each jurisdiction.
b. Automated SEC Filing Generation: The platform automatically generates and submits required regulatory filings, including Form D for Regulation D offerings, ongoing disclosure reports for Regulation A+offerings, and other documentation required by securities regulators.
c. Investor Accreditation Verification: For offerings limited to accredited investors, the platform integrates with digital identity verification services and financial data providers to automate and periodically revalidate investor accreditation status in compliance with SEC requirements.
d. AML/KYC Integration: The platform incorporates advanced anti-money laundering and know-your-customer protocols, utilizing AI-powered risk assessment tools to identify suspicious transaction patterns and maintain compliance with FinCEN requirements.
e. Compliance Documentation Trail: All compliance-related actions and verifications are recorded on the blockchain with timestamped hashes of supporting documentation, creating an immutable audit trail that can be accessed by regulators when required while protecting sensitive user data.

### Interest Calculation and Distribution

The application accurately calculates and tracks interest accrual based on jurisdiction-specific rates and rules. Some jurisdictions have fixed interest rates, while others use variable rates or bidding systems where investors compete by bidding down the interest rate.

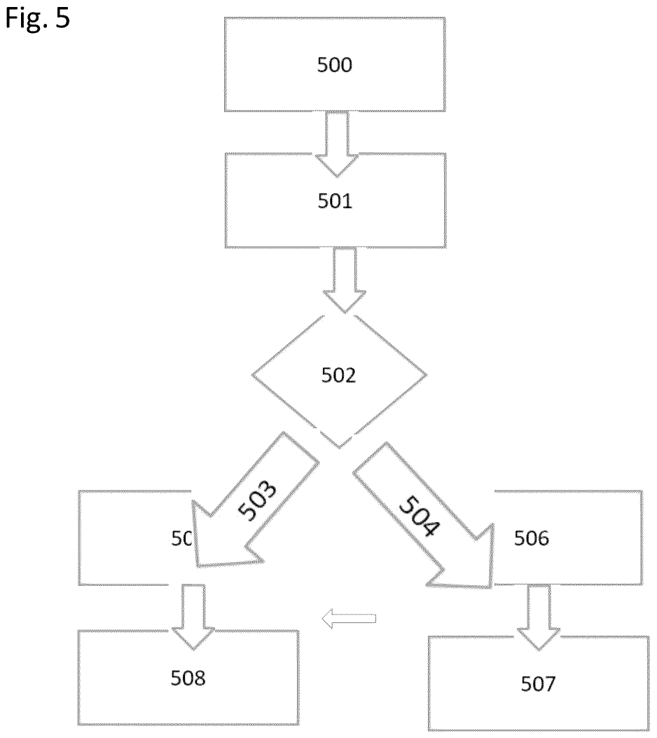

Referring to FIG. 5, the redemption and distribution process begins when property owner pays redemption amount (500) to satisfy the outstanding tax lien obligation. The system then initiates smart contract calculates total due (501) automatically computing the complete redemption amount including principal, accrued interest, and any subsequent tax payments made by investors according to jurisdiction-specific interest rates and calculation methodologies. The process reaches a decision point for group or individual (502) to determine the appropriate distribution mechanism based on the ownership structure of the tax lien token.

For individual ownership, the system follows individual path (503) leading to direct transfer to investor wallet (505) where the complete redemption proceeds are immediately transferred to the individual investor's digital wallet. For group ownership structures, the system follows group path (504) directing funds to send to group contract (506) where the group investment smart contract receives the total redemption amount. The group contract then executes distribute proportionally to members (507) automatically calculating and transferring each member's proportional share based on their ownership percentage in the group investment. Finally, the process concludes with burn/close token (508) where the redeemed tax lien token is permanently removed from circulation, completing the investment lifecycle and updating all relevant blockchain records to reflect the successful redemption

The application provides real-time tracking of interest accrual, allowing users to monitor the performance of their investments and make informed decisions about selling on the secondary market or holding until redemption.

### Foreclosure Process Facilitation

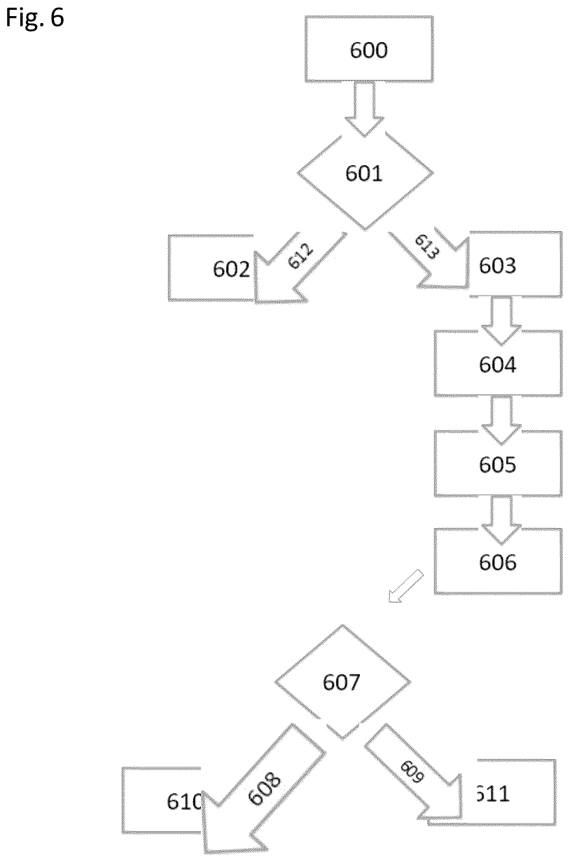

Referring to FIG. 6, the foreclosure process begins with track redemption deadline (600) where the system continuously monitors tax lien redemption periods and automatically triggers alerts as deadlines approach. The system reaches a decision point for redeemed (601), and if the property owner has satisfied the obligation, the process follows the yes path (609) to process redemption (602) directing to the redemption workflow detailed in FIG. 5. If the tax lien remains unredeemed, the system follows the no path (608) to initiate foreclosure (603) beginning the legal foreclosure proceedings. The system then executes generate legal documents (604) creating jurisdiction-specific foreclosure paperwork including notices, affidavits, and court filings based on local legal requirements. Next, the process proceeds to file foreclosure paperwork (605) submitting required documentation to appropriate courts and government agencies. The system then manages the court process (606) coordinating with legal service providers and tracking procedural requirements. At the decision point for granted (607), if the foreclosure is denied, the system follows the no path (612) to return to application process (610) allowing investors to address deficiencies and refile. If the foreclosure is approved, the system follows the yes path (613) to transfer property ownership (611) completing the legal transfer of property title to the investor and updating all relevant blockchain records to reflect the successful foreclosure completion.

The application generates necessary legal documents based on jurisdiction-specific requirements and provides resources to understand the process in their specific jurisdiction. It connects users with legal service providers who can assist with the foreclosure process, including filing paperwork, serving notices, and representing the investor in court if necessary.

Smart contracts can automate certain steps of the foreclosure process, such as sending certified notices, scheduling important dates, and tracking progress. Once the foreclosure is complete, the property ownership is transferred to the investor, and the application can assist with property management or sale.

### Enhanced Group Investment Management

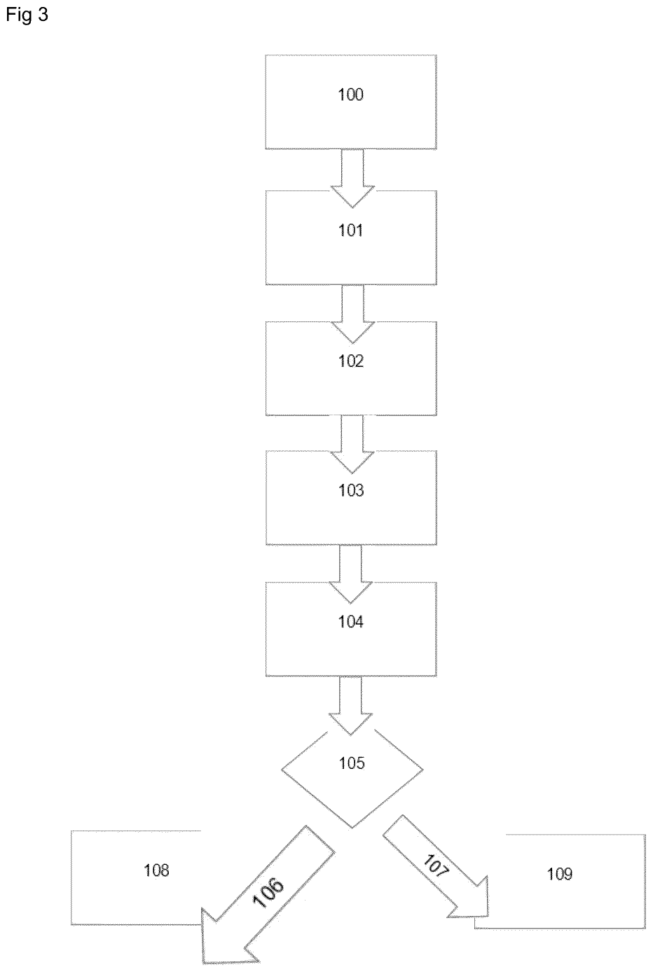

Referring to FIG. 3, the group investment process begins with create investment group (100) where founders establish new collaborative investment entities. The system proceeds to define investment strategy (101) where group creators set investment criteria, risk parameters, and governance rules. Members contribute MATIC (102) to the group fund smart contract (103) which securely holds and manages the pooled investment capital. The system then facilitates purchase tax liens (104) using the aggregated funds according to the predefined investment strategy. At the investment decision point (105), the system differentiates between major decisions (106) and minor decisions (107) based on predetermined governance thresholds.

Major decisions (108) require majority or supermajority vote from all group members regardless of ownership stake, ensuring critical actions such as changing investment strategy or initiating foreclosure have broad member support. Minor decisions (109) are weighted by ownership percentage, allowing routine operational decisions to be made efficiently while maintaining proportional influence based on each member's financial contribution to the group investment pool.

The Group Investment Contract allows users to create investment groups, define investment criteria, and contribute MATIC to a shared pool. Group creators can set minimum contribution amounts, investment objectives, and governance rules. Other users can browse available groups and join those that align with their investment goals.

The application incorporates several innovative governance mechanisms:
a. Quadratic Voting Mechanism: Rather than simple proportional voting based on ownership stake, the platform offers optional quadratic voting protocols for group decisions, where voting power scales with the square root of ownership percentage. This approach prevents large stakeholders from dominating decision-making while still giving proportional influence.
b. Delegated Voting Rights: The platform enables investors to delegate their voting rights to trusted experts within the group or to third-party advisors, allowing for more informed decision-making without requiring all investors to develop specialized knowledge.
c. Proposal Templates and Simulation: The platform provides standardized proposal templates for common investment decisions, along with simulation tools that allow investors to model the potential outcomes of different choices before voting.
d. Time-Weighted Governance Rights: The system optionally supports governance models where long-term investors receive enhanced voting rights, incentivizing stable ownership and discouraging short-term speculation.

Certain critical actions, such as changing the group's investment strategy or initiating foreclosure, require a majority or supermajority vote from all members, regardless of ownership stake, ensuring important decisions have broad support within the group.

The application facilitates communication among group members through integrated messaging and notification systems, ensuring all members are informed about the investment's status and any pending decisions. It also provides tools for group formation, allowing users to create or join investment groups based on shared interests and investment strategies.

To maintain transparency and accountability, all group investment transactions and decisions are recorded on the blockchain, creating an immutable audit trail. This fosters trust among group members and enables easy dispute resolution if needed.

### Operational Flow

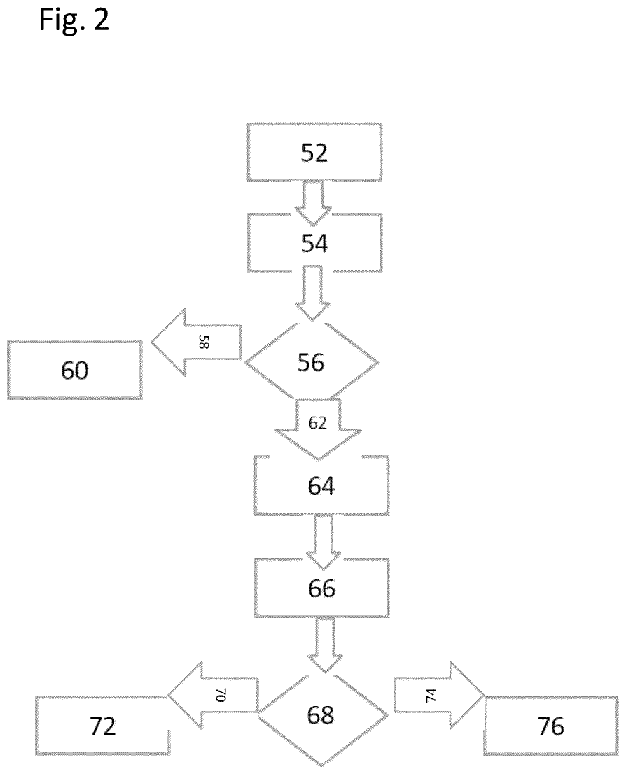

Referring to FIG. 2, the user journey begins with user registration (52) where applicants provide necessary identity information and documentation. The system then initiates KYC/AML verification processing (54) using third-party verification services to validate user identity and perform comprehensive anti-money laundering checks against global compliance databases. The verification decision point (56) determines approval status, and if verification fails (58), users are directed to return to registration (60) to correct deficiencies or provide additional documentation. Upon successful verification approval (62), users proceed to fund their digital wallet (64) with MATIC tokens through integrated payment processing systems. Users can then browse investment opportunities (66) where the application presents vetted tax lien investment options with comprehensive property information, risk assessments, and filtering capabilities for location, amount, interest rate, and risk level. At the investment type decision point (68), users choose between individual investment path (70) leading to direct individual investment processing (72) for immediate tax lien token purchases, or group investment path (74) leading to join/create group functionality (76) where users can either join existing investment groups or create new collaborative investment entities with customized governance parameters and investment strategies.

Once approved, users can fund their digital wallets with MATIC and start exploring vetted tax lien investment opportunities presented by the application. The application retrieves tax lien information from local government databases and presents it in a user-friendly format, with filters for location, amount, interest rate, and risk level.

### Data Analytics and Risk Assessment Module

The application includes a sophisticated data analytics and risk assessment module that leverages artificial intelligence to enhance investment decision-making:
a. Predictive Analytics for Redemption: The system utilizes machine learning algorithms trained on historical tax lien data to predict the likelihood of redemption for different property types and jurisdictions, helping investors make more informed investment decisions.
b. Portfolio Diversification Tools: The platform provides advanced portfolio analysis tools that help investors optimize their tax lien investments across different geographic regions, property types, and risk profiles to achieve desired risk-return characteristics.
c. Market Sentiment Analysis: By analyzing transaction patterns, on-chain metrics, and external market data, the system provides insights into overall market sentiment and liquidity trends for tokenized tax liens.
d. Automated Valuation Models: The platform incorporates AI-driven valuation models that continuously assess the fair market value of tax lien tokens based on underlying property characteristics, redemption probabilities, and comparable sales data.

### Enhanced User Education and Risk Management

The system educates users on the risks and complexities of tax lien investments through interactive tutorials, FAQs, and access to professional resources. The education module covers topics such as understanding redemption periods, interest calculations, foreclosure processes, and potential risks associated with property condition and value.

Risk assessment tools help users make informed decisions based on their risk tolerance. The application provides property risk scores based on factors such as location, property type, owner's payment history, and property value relative to the tax lien amount. Users can filter investment opportunities based on these risk scores and set investment criteria that align with their risk tolerance.

### The Platform Also Implements:

a. Interactive Scenario Simulations: Users can explore various investment scenarios with different parameters to better understand potential outcomes under various market conditions.
b. Customized Risk Profiles: The system creates personalized risk assessments based on individual investor preferences, financial situation, and investment objectives.
c. Community-Based Learning: A moderated forum allows investors to share experiences, strategies, and lessons learned, fostering a community of informed participants.
d. Expert Advisory Network: The platform connects users with licensed professionals specializing in tax lien investments for situations requiring more personalized guidance.

### Investment Process

Users can choose to invest individually or join an investment group. If investing individually, they can directly purchase tax lien tokens using MATIC. If joining a group, they contribute MATIC to the group's smart contract, which then invests in selected tax liens based on the group's predefined strategy.

Throughout the investment lifecycle, the application keeps users informed through notifications and updates. It automates key processes such as interest distribution, redemption tracking, and foreclosure initiation based on user preferences and jurisdiction-specific rules.

If a tax lien is redeemed, the smart contract automatically distributes the principal and interest to individual investors or the group's smart contract, which then distributes the funds to group members proportionally. If the lien is not redeemed, the application guides users through the foreclosure process, with smart contracts automating certain steps.

At any point, individual investors can choose to sell their tax lien tokens on the secondary market provided by the application. Group members can propose and vote on liquidating the group's investment, with the smart contract executing the sale and distributing funds to members if the proposal is approved.

The application continues to provide post-investment support, including legal guidance, property management resources, and tools for tracking and optimizing the investment portfolio. By leveraging blockchain technology and smart contracts, the application streamlines the entire tax lien investment process while ensuring transparency, security, and efficiency.

### Enhanced Security Measures

The application incorporates state-of-the-art security features to protect investor assets and data:
a. Multi-Layer Authentication: Access to investment functions requires multi-factor authentication, including biometric verification for high-value transactions and sensitive account changes. The platform also supports hardware security keys and offline signing for institutional investors.
b. Formal Verification of Smart Contracts: All smart contracts undergo rigorous formal verification through mathematical proofs to ensure they function exactly as intended without vulnerabilities. This process is combined with third-party security audits and open bounty programs to identify and resolve potential security issues.
c. Secure Escrow Mechanisms: For transactions involving foreclosure processes or property transfers, the application implements time-locked escrow contracts with multi-signature authorization requirements, ensuring that funds and ownership rights are properly transferred according to predetermined conditions.
d. Privacy-Preserving Transaction Protocols: While maintaining full transparency for regulatory compliance, the system employs zero-knowledge proofs and other privacy-enhancing technologies to protect sensitive investor information and proprietary investment strategies.
e. Real-time Threat Monitoring: The system continuously monitors transaction patterns and user activity to detect and prevent potential security threats, including account takeovers, flash loan attacks, and market manipulation attempts.
f. Secure Key Management: The platform implements advanced key management protocols, including optional multi-signature wallets, threshold signatures, and social recovery mechanisms to prevent unauthorized access and mitigate the risk of lost private keys.
g. Insurance Coverage: The platform partners with blockchain-focused insurance providers to offer optional coverage against smart contract failures, oracle malfunctions, and other technical risks that could impact investor assets.

### Advantages of the Invention

The present invention provides numerous advantages over traditional tax lien investment methods:
a. Accessibility: By lowering minimum investment amounts through fractional ownership and providing a user-friendly interface, the application makes tax lien investments accessible to a broader range of investors.
b. Transparency: All transactions and investment information are recorded on the blockchain, providing an immutable audit trail and enhancing trust among group investors.
c. Efficiency: Smart contracts automate many aspects of the investment process, reducing manual intervention and potential errors.
d. Liquidity: The secondary market addresses one of the significant limitations of traditional tax lien investments by providing an exit mechanism before redemption or foreclosure.
e. Risk Management: Comprehensive property information, risk assessment tools, and educational resources help users make informed investment decisions.
f. Global Participation: By using digital currency and a blockchain platform, the application enables global investment in local tax liens, expanding the potential investor base.
g. Cost Reduction: By eliminating intermediaries and automating processes, the application reduces the costs associated with tax lien investments.

1. A system for facilitating the purchase and management of real estate tax liens comprising: a blockchain platform utilizing Polygon technology; smart contracts deployed on said blockchain platform configured to manage user registration, tokenization of tax lien certificates, investment management, and secondary market transactions; a digital currency wallet interface configured for transactions in MATIC; a tokenization module configured to represent tax lien certificates as digital tokens with associated metadata; a user interface configured to provide access to tax lien investment opportunities and manage user interactions; a group investment module configured to enable collective investment and governance; a secondary market module configured to enable trading of tokenized tax lien certificates.

2. The system of claim 1, wherein the smart contracts further comprise: a User Management Contract configured for user registration and verification; a Tax Lien Token Contract configured for creating, transferring, and redeeming tokens; a Group Investment Contract configured for governing collective investment decisions; a Secondary Market Contract configured for facilitating token trades; a Redemption and Distribution Contract configured for managing redemption payments and returns; a Foreclosure Management Contract configured to handle foreclosures on non-redeemed liens; a Compliance Engine Contract configured for regulatory compliance checks; and a Risk Assessment Contract configured to provide investment risk analyses.

3. The system of claim 1, wherein the group investment module implements a governance model with voting power proportional to member ownership stakes.

4. The system of claim 1, wherein the tokenization module generates non-fungible tokens (NFTs) representing ownership of tax lien certificates, including metadata such as property details, purchase date, interest rate, and redemption deadline.

5. The system of claim 1, further comprising an integration module configured to interface with external data providers, including title companies, government databases, and legal service providers.

6. The system of claim 1, further comprising a risk assessment module configured to evaluate and score tax lien investments based on property details and historical data.

7. The system of claim 1, further comprising an educational module configured to offer interactive educational resources related to tax lien investments.

8. A method for facilitating the purchase and management of real estate tax liens, comprising: retrieving tax lien data from government databases; tokenizing tax lien certificates into digital assets on a blockchain; enabling the purchase of tokens using digital currency; tracking redemption periods and calculating accrued interest; automatically distributing redemption proceeds to token holders; facilitating foreclosure processes for liens not redeemed; and enabling token trading through a blockchain-based secondary market.

9. The method of claim 8, further comprising implementing group governance wherein decision-making is proportional to ownership stake.

10. The method of claim 8, further comprising automating due diligence processes through integration with external data sources.

11. The method of claim 8, further comprising generating legal documents necessary for foreclosure processes.

12. The method of claim 8, further comprising assessing investment risks using a multi-factor scoring system.

13. The method of claim 8, further comprising providing educational materials to users regarding risks associated with tax lien investments.

14. The method of claim 8, further comprising recording transaction data immutably on the blockchain to ensure transparency.

15. A non-transitory computer-readable medium storing instructions executable by a processor to perform the method of claim 8.

16. The system of claim 1, wherein the smart contracts include dynamically updatable compliance parameters to adapt to various regulatory jurisdictions.

17. The system of claim 1, wherein token metadata is dynamically updated to reflect changes in property information and lien status.

18. The system of claim 1, further comprising a cross-chain interoperability module enabling trading across multiple blockchain platforms.

19. The system of claim 1, wherein the secondary market module interfaces with Alternative Trading Systems (ATS) compliant with regulatory requirements.

20. The system of claim 3, wherein the governance model incorporates quadratic voting to balance voting power among members.

21. The system of claim 1, further comprising a predictive analytics module using machine learning to forecast redemption probabilities.

22. The system of claim 1, wherein decentralized oracles provide real-world data for real-time valuation adjustments.

23. The system of claim 1, further comprising an automated regulatory compliance engine configured to produce and submit required regulatory documentation and filings.
